(19) United States
(12) Patent Application Publication
(10) Pub. No.: US 2008/0174174 A1
(43) Pub. Date: Jul. 24, 2008

(54) Passive Truck Trailer Braking Regeneration and Propulsion System and Method

(75) Inventors: James S. Burns, El Cajon, CA (US); Thomas L. Bartley, (US)

Correspondence Address: PROCOPIO, CORY, HARGREAVES & SAVITCH LLP, 530 B STREET, SUITE 2100, SAN DIEGO, CA, 92101, US

(73) Assignees: James S. Burns, El Cajon, CA (US); ISE CORPORATION, Poway, CA (US)

(21) Appl. No.: 11/625,504

(22) Filed: Jan. 22, 2007

(51) Int. Cl. B60T 8/64; G06F 17/00

(52) U.S. Cl. 303/152; 701/48

(57) ABSTRACT

A braking regeneration and propulsion system for a passive trailer including wheels with axles includes a gear box to be operatively coupled to the axle; a motor/generator operatively coupled to the gear box; an energy storage system for storing captured energy and supplying energy; and a control computer to assist deceleration of the passive trailer by causing the axle to drive the motor/generator via the gear box and supply energy to the energy storage system during deceleration, and, assist acceleration of the passive trailer by causing the motor/generator to draw energy from the energy storage system and drive the wheels via the gear box and axle during acceleration.

### BACKGROUND OF THE INVENTION

1. Field of the Invention

The field of the invention relates to braking energy regeneration systems and methods that capture and recycle wasted energy.

2. Background of the Invention

The gross weight limit in California of a semitrailer resting on two tandem axles is 68,000 pounds with 34,000 pounds on the rear tandem axles. For other trailers the California weight limit is 18,000 pounds per axle. It is estimated that a 68,000 pound semitrailer traveling at 55 mph dissipates about 2.6 kWh of kinetic energy as heat and brake wear every time the semitrailer is slowed to a stop. At 75 mph the kinetic energy of a 68,000 pound trailer is 4.8 kWh. Therefore, the 34,000 pounds on the rear axles alone is responsible for 1.3 kWh and 2.4 kWh at 55 mph and 75 mph, respectively.

Hybrid drive systems for trucks and tow tractors have been in development for a number of years. Although it is known in hybrid drive systems for trucks and tow tractors to recover usually discarded braking energy, it is not known to provide a separate braking energy regeneration system and method in a passive semitrailer or a trailer towed by a motor truck or truck tractor to capture and recycle wasted energy,

### SUMMARY OF THE INVENTION

Accordingly, aspects of the invention involve braking energy regeneration systems and methods that capture and recycle wasted energy in a passive semitrailer or a trailer when towed by a motor truck or truck tractor, and the recycling of that energy to assist in the propulsion of the semitrailer or trailer.

One aspect of the invention involves a trailer axle-mounted braking regeneration system and method that allows the capture and recycling of this wasted energy. The braking regeneration system and method of the present invention is applicable to, but not limited to, single, tandem, and other multiple axle semitrailers, including open and enclosed configurations; and other passive trailers such as flat bed trailers, tank trailers, bulk material trailers, box trailers, fuel trailers, specialty trailers, house trailers, and any other passive trailers that are not self propelled. The braking energy stored in the energy storage can be recycled to assist in the trailer acceleration and/or to provide power to the trailer loads such as the energy required to operate a refrigeration unit and an air compressor for the air brake system. This is especially helpful as free energy on long downhill grades and as a stress relief system for the towing vehicle and towed trailer friction braking systems.

Another aspect of the invention involves a braking regeneration and propulsion system for a passive trailer including an axle with wheels, the passive trailer primarily propelled by a separate pulling vehicle. The braking regeneration and propulsion system includes a gear box to be operatively coupled to the axle; a motor/generator operatively coupled to the axle gear box; an energy storage system for storing captured energy and supplying energy; and a power switching device to manage the energy flow that is controlled by a control computer to assist deceleration of the passive trailer by causing the axle to drive the motor/generator via the gear box and supply energy to the energy storage system during deceleration, and, assist acceleration of the passive trailer by causing the motor/generator to draw energy from the energy storage system and drive the wheels via the gear box and axle during acceleration. The gear box can be a differential gear box for more efficiently transmitting the different torques and speeds of the inside and outside wheels when the trailer is not traveling in a straight line.

In an alternative aspect of the invention, a gear box operatively coupled to the axle and a motor/generator operatively coupled to the gear box are replaced by one or more motor/generator(s) that is operatively coupled to the axle, is part of the axle, or is part of one or more of the wheels attached to the axle. Thus, rather than a differential gear box operatively coupled to the axles of the inside and outside wheels, the inside and outside wheels are each independently coupled to their own gear box, motor/generator; and each motor/generator is independently controlled for the torque and speed differences of the inside and outside wheels when the trailer is not traveling in a straight line.

In a further aspect of the invention a braking resistor or hydraulic retarder is coupled to the motor/generator to dissipate braking energy when the energy storage system is full. Using the braking resistor or hydraulic retarder to dissipate energy saves wear and tear on the trailer brakes and extends the interval between required brake service.

In an optional control aspect of the invention, information as to whether the trailer is being pulled in acceleration or restrained in deceleration and the amount of pull and restraint is provided from the manual accelerator and braking controls of the towing vehicle or from a sensor, e.g., a strain gage, that is part of the towing connection between the passive trailer and the towing vehicle. The chosen sensor system provides this information to the energy flow switching control between the trailer axle motor and the energy storage system.

Another aspect of the invention involves a method of using a braking regeneration and propulsion system with a passive trailer including an axle with wheels, the passive trailer primarily propelled by a separate pulling vehicle. The method includes providing a braking regeneration and propulsion system including: a gear box to be operatively coupled to the axle; a motor/generator operatively coupled to the gear box; an energy storage system for storing captured energy and supplying energy; and a power switching device to manage the energy flow that is controlled by a control computer to assist deceleration of the passive trailer by causing the axle to drive the motor/generator via the gear box and supply energy to the energy storage system, and assist acceleration of the passive trailer by causing the motor/generator to draw energy from the energy storage system and drive the wheels via the gear box and axle; assisting deceleration of the passive trailer by causing the axle to drive the motor/generator via the gear box and supply energy to the energy storage system or to a braking resistor when the energy storage system is full; and assisting acceleration of the passive trailer by causing the motor/generator to draw energy from the energy storage system and drive the wheels via the gear box and axle.

In an alternative aspect of the invention, a gear box operatively coupled to the axle and a motor/generator operatively coupled to the gear box are replaced by one or more motor/generator(s) that is operatively coupled to the axle, is part of the axle, or is part of one or more of the wheels attached to the axle.

A typical trailer rests on multiple axles or on multiple chassis supports with multiple axles. Thus, in one or more implementations of the above aspects of the invention, the invention is replicated in part or in whole for each trailer axle or for each trailer wheel.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a block diagram depicting an embodiment of an axle-mounted braking regeneration system for a passive trailer.

FIG. 2 is a block diagram depicting an embodiment of the axle-mounted braking regeneration system on a multi-axle passive trailer.

FIG. 3 is a block diagram depicting an embodiment of a trailer energy storage system supplying accessory power to a refrigeration system of a “refer” trailer or to an air compressor for trailers with an air brake system.

FIG. 4 is a block diagram illustrating an exemplary computer system used in connection with the various embodiments described herein.

### DETAILED DESCRIPTION OF A PREFERRED EMBODIMENT

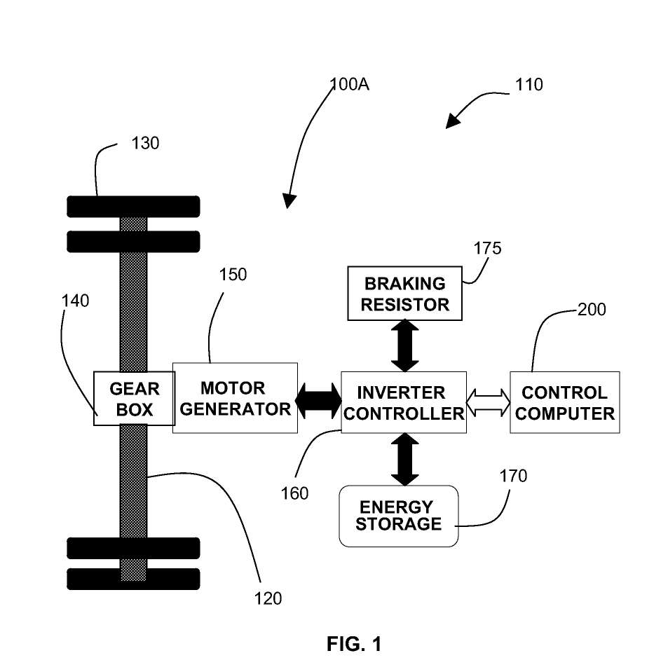

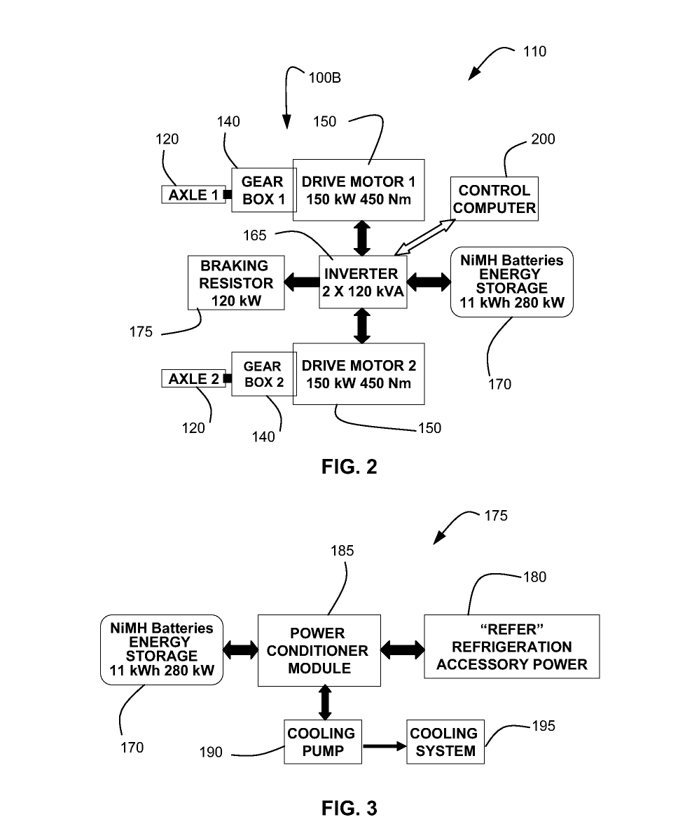

With reference to FIGS. 1 and 2, embodiments of axle-mounted braking regeneration energy storage and acceleration systems 100A, 100B and method for a passive trailer 110, separate and independent of the towing vehicle, will be described. The braking regeneration system 100 is “separate” in that it is separate and distinct from any other possible braking regeneration system in the towing vehicle. Thus, the braking regeneration system 100 is not part of any single braking regeneration system for the towing vehicle or the towing vehicle and trailer. As used herein, “passive trailer” refers to a trailer primarily propelled (e.g., pulled) by a separate driving vehicle (e.g., truck, tractor). A passive trailer has no primary power unit for the conversion of chemical fuel into electric or kinetic energy used to propel the vehicle. A trailer is defined as a towed wheeled vehicle where the frame structure exists to support the transportation of a fixed or temporary load from one location to another location. Although the braking regeneration systems 100A, 100B will be described as being axle-mounted, in alternative embodiments, the braking regeneration systems 100A, 100B are mounted to other and/or additional structures of a passive trailer. The gear box 140 depicted in FIG. 1 is a differential gear box to transmit the different torques and speeds of the inside and outside wheels when the trailer 110 is not traveling in a straight line. Alternative embodiments also include independently suspended wheel axles that are not structurally connected to the corresponding wheel axle on the other side of the trailer 110 chassis. In these alternative embodiments the acceleration and deceleration torques must be matched transversely across the trailer 110 to prevent any inadvertent turning or twisting torques to destabilize the control of the trailer. Different torques and speeds of the inside and outside wheels occur when a trailer 110 is not traveling in a straight line such as turning around a bend or corner. When these different torques are independently applied by separate motors and controllers, they may be intentionally used for trailer 110 steering assistance when the trailer 110 is being pushed (or backed) into a loading/unloading dock or parking position.

In the embodiment of the braking regeneration system 100A shown in FIG. 1, the passive trailer 110 is a trailer including one axle 120 with wheels 130 on opposite ends of the axle 120 and a friction braking system attached to each wheel 130. The axles 120 rotate with rotation of the wheels 130. In the embodiment of the braking regeneration system 100B shown in FIG. 2, each trailer 110 includes two axles 120 and each axle 120 has two or four wheels. In one or more implementations of the embodiments described herein, the drive and braking regeneration system is repeated for each trailer axle 120, is only associated with a single trailer axle 120, or is associated with some, but not all, of the trailer axles 120. Although the braking regeneration system 100 will be described as being used with a semi-tractor hauled trailer, in alternative embodiments, the braking regeneration system is applied to other passive trailers other than a semi tractor hauled trailer such as, but not by way of limitation, bob tail trailer, flat trailer, tank trailer, box trailer, bulk material trailer, fuel trailer, container trailer, and farm trailer. Further, although the braking regeneration system will be described at times as being used with a single passive individual trailer 110, in alternative embodiments, the axle-mounted braking regeneration system is applied to a linked series of multiple passive trailers.

Any element shown and/or described herein in the singular applies to one or more of such elements.

In the embodiments shown, the braking regeneration systems 100A, 100B include a gear box 140 and a motor/generator 150 for each axle 120, a single inverter/controller 160 (FIG. 1) per axle or a dual-inverter 165 (FIG. 2) per two axles 120, a single energy storage system (“energy storage”) 170 per trailer 110, a single braking resistor 175 per dual-inverter, and a single control computer 200 per trailer 110. The gear box 140 shown as part of the braking regeneration system 100A in FIG. 1 is typically a differential gear box design to balance the propulsion and braking torques and speeds between the inside and outside wheels 130 during both straight and turning travel. In alternative embodiments, one or more of the number of wheels, axles, passive trailers, braking regeneration systems, components of the braking regeneration system, and/or other elements described herein may vary in type, configuration, and/or number from that shown and described herein. For example, but not by way of limitation, in alternative embodiments, the braking regeneration system includes one larger generator/motor incorporated on one axle 120 per trailer 110 or two smaller gearbox/motor/generator systems, one on each axle 120 of a two-axle trailer 110.

The gear box 140 is mechanically connected to the axle 120. The gear box 140 transfers torque between the axle 120 and the motor/generator 150. At the same time as the gear box 140 provides a speed reduction to match the motor rpm to the axle shaft rpm, the torque increases by the same ratio as the speed reduction. In another alternative embodiment, any required rpm speed reduction occurs in the motor connection to the axle 120 and a separate gear box 140 is not required. In yet other alternative embodiments, the gear box 140 includes a clutch, multiple gears and a transmission.

In the embodiment of the braking regeneration system 100B illustrated in FIG. 2, the single dual-inverter 165 controls both axle drive motor/generators 150 on the trailer 110 and performs the power flow switching for the operation of the energy storage 170 and the braking resistor 175.

The motor/generator 150 along with the dual-inverter 165 can be Siemens ELFA components that are used on electric and hybrid-electric heavy-duty vehicles. The motor/generator 150 generates energy during braking regeneration and applies torque to the wheels 130 via the gear box 140 and axle 120 during an acceleration mode. In the embodiments shown, the motor/generator 150 is a combined, integrated motor and generator; however, in an alternative embodiment, motor/generator 150 includes physically separated motor and generator.

Referring to FIG. 3, in another alternative embodiment, the energy storage 170 includes or is part of a central energy storage system 175. In the embodiment shown, the central energy storage system 175 includes the energy storage 170 and a power conditioner module 185 for converting to other AC and DC formats to provide for the power needs 180 of a refrigeration trailer 110, commonly known as a “refer”. The power conditioner module 185 also includes power to drive cooling pumps 190 and cooling fans of a cooling system 195. In alternative embodiments, the power conditioner module 185 provides for power needs (e.g., trailer emergency power, trailer accessory power) on the trailer 110 in addition to or instead of the powering the cooling pumps 190 and cooling fans. Trailer accessory power needs include, but are not limited to, compressed air for an air brake system, lighting, heating, ventilation, air conditioning (HVAC), and plug-in power for electric and electronic devices. In one embodiment of the invention, the inverter and power conditioning module 185 replaces all or part of the power normally supplied by the auxiliary engine refrigeration unit mounted on the refer trailer.

In alternative embodiments, one or more other types of energy storage 170 are used such as, but not limited to, one or more or a combination of different battery chemistries, ultracapacitors, flywheels, springs and/or hydraulic accumulators.

In another embodiment of the invention, the motor/generator 150, the dual-inverter 165, the energy storage 170, the power conditioner module 185, and the braking resistors 175 are liquid cooled. The liquid cooling loop, not shown, consists of liquid coolant, typically 50/50 water/ethylene glycol, a heat exchanger radiator with electric fans, and coolant pumps 190 to circulate the coolant. One or more coolant loops are used on the trailer 110 to manage the temperature of the electric power components 150, 160, 165, the energy storage 170, the braking resistor 175, the power conditioner module 185, and the HVAC system.

In an implementation of this embodiment of the invention, one of the cooling loops includes the braking resistors 175, which serve two different functions. The braking resistors 175 are high power electrical resistors that dissipate power by heating a circulating fluid. The coolant heat is dissipated in one or more of a heat exchanging radiator that radiates heat to the air passing through the heat exchanger, a heat exchanging radiator to heat the interior compartment air of the trailer, a coolant loop through the energy storage to warm the energy storage 170, and/or any other component on the trailer that would benefit from receiving additional heat from the coolant or heated air from a heat exchanger. When the motor/generator 150 is generating more power than can be stored in the energy storage 170 and used by the auxiliary power 180, the inverter controller 165 switches the excess power to the braking resistor(s) to heat the circulating coolant. For example, this occurs when the braking regeneration electromagnetic braking is used rather than add wear to the normal friction brakes. This is helpful in preventing brake “fade” during long and/or steep downhill descents. In another use of the braking resistors 175, the braking resistors 175 are heated by the energy storage 170 and used to supply heat via the circulating fluid to a heat exchanger radiator for heating the passenger compartment of the commuter trailer.

The control computer 200 controls operation of the braking regeneration system 100 in the manner described herein. The braking regeneration systems 100A, 100B are controlled by the control computer 200 to initiate the acceleration and deceleration modes without lurching the trailer 110 and compressing or decoupling the towing coupler. Real time onboard sensors along with optional towing vehicle information provide input that is processed by processor(s) of the control computer 200 using the computer control algorithms related to applying power or drag to the trailer wheels.

The braking regeneration systems 100A, 100B will now be described in use, during deceleration and acceleration of the trailer 110.

On deceleration, the generator 150 puts a drag on the axle 120 to slow down the trailer 110. System controls prevent the trailer 110 from abruptly compressing and extending the coupler. When towing multiple trailers, the individual trailers 110 have their systems activated in an in-line or series configuration, one at a time, to prevent lurching. One or more control computers 200 of the trailer(s) is separate from any control computer for any braking regeneration system of the towing vehicle, and is transparent to the towing vehicle. In an embodiment of the invention, the trailers 110 operate as an integrated control system. Below a minimum speed, for example 3 mph, the braking regeneration system 100A, 100B is turned off and the standard friction brake system is applied to stop the trailer 110.

The energy captured from deceleration is, in turn, fed through the inverter/controllers 160, 165 and into the nickel metal hydride (NiMH) battery energy storage system 170. The charge and discharge levels of the nickel metal hydride (NiMH) battery energy storage system 170 are limited to extend the cycle life of the energy storage system 170. Lithium (Li) ion type of battery pack offers an alternative to the NiMH battery pack. Ultracapacitors also offer alternative energy storage for this application. However, in an alternative embodiment of the invention, an ultracapacitor pack is incorporated with the battery pack to protect and extend the life of the battery pack.

On acceleration, the recycled stored energy is consumed as the motor/generators 150 are then configured as electric motors 150 to assist the tractor accelerate the trailer. As an example, the electric motor/generators 150 operate for less than 60 seconds at a peak power level during acceleration until the tractor reaches cruise speed and the electric motor/generators 150 are no longer needed. Alternatively, a lower power level for a longer period of time during acceleration puts less stress on the components resulting in lower maintenance costs, increased system life, and improved reliability. For example, a longer period of time would be useful to climb a long grade. A navigation system could provide the control computer position information to identify the grade and manage the energy storage accordingly. The energy management system has an infinite variability of control parameters to provide for optimization of the energy capture and recycle. During cruise speed, power is obtained from the electric motor/generators 150 to provide the power needs 180 of a refer unit.

The acceleration performance of a tractor-trailer is improved and/or a smaller engine can be used in the tractor to haul the power assisting trailer 110.

The braking regeneration systems 100A, 100B are retrofitted onto existing trailers 110 and/or implemented into the original manufacture of the trailer and/or trailer chassis. The energy storage 170 is managed by establishing a depletion point of the energy storage system 170 at a level that insures that the energy storage system 170 will always be able to operate. With the amount of onboard energy storage, the braking regeneration system 100A, 100B will start up automatically from an overnight layover. Should the energy drop to a minimum threshold, three ways to start up the braking regeneration system 100A, 100B include: 1) pull the trailer 110 to turn the axles 120 and generators 150, 2) use a tractor connection to provide electric power from the truck engine generator, and 3) use an external grid-based charger.

The first method is preferred and self managed. At start up, the generators 150 operate while the tractor is pulling the trailer 110. The generators 150 place an extra drag on the tractor for a short time until the energy storage system 170 was at an operating level ready to accept the first deceleration energy capture. Normally, the first trailer deceleration would bring the energy storage system 170 to an operating capacity level, preparing it for the next acceleration event. Each deceleration event adds to the energy storage 170 state of charge (SOC) to achieve a full working level.

If desired, the other two methods are also available. A grid based charger connects the energy storage system 170 to a wayside power supply whereby the passive trailer 110 becomes a electric plug-in power assisted vehicle.

Another advantage of implementation of the braking regeneration system 100A, 100B on a passive trailer 110 includes extending the brake service life. For example, because the recovered energy has been taken away from the generation of heat and wear in the brake system, the brake wear and corresponding maintenance for the brake system is reduced. The trailer decelerates by capturing energy on deceleration, while reducing the burden on the conventional friction braking system. In hybrid-electric buses that use brake regeneration, brake maintenance intervals have been at least doubled. Therefore, a conservative estimate is that a 50% savings would be realized on the maintenance of the trailer brake system. This would double the current reline interval of the trailer 110 thus reducing the required labor and materials to perform reline service maintenance.

The primary economic advantage to the towing vehicle is a recycling of the braking energy to reduce fuel consumption. Additional advantages occur during start up and grade climbing accelerations when the towing vehicle would experience superior acceleration performance because the towed trailer would appear to be a lighter weight vehicle. Similarly, slowing and down grade decelerations would put less stress on the friction braking systems giving the towing vehicle more operating speed range without fear of over heating the brakes.

In an embodiment of the system 100A, 100B, the system 100A, 100B provides adequate power so that each trailer 110 provides energy for itself, thus, reducing the auxiliary power requirements. The braking regeneration energy storage system 100A, 100B provides power for all hotel loads on the trailer 110 including refer, HVAC, lighting and communications. Because the battery energy storage 170 supplies power to the trailer 110 through the power conditioner module 185, any separate independent engine-generator set requirements are significantly reduced or eliminated. If it is desired to transfer power from the tractor to the trailer, it is through the wheels 130 by using the braking generator 150.

An alternative embodiment of a braking regeneration system uses hydraulic components where a hydraulic motor/pump replaces the electric motor/generator 150; a hydraulic valve controller replaces the electric inverter switch controller 160; a hydraulic accumulator replaces the energy storage 170; and a hydraulic retarder replaces the braking resistors 165. The hydraulic retarder requires some form of liquid or air heat exchanger to dissipate energy. In its simplest form a hydraulic braking regeneration system is the hydraulic analog of the electric braking regeneration system and is a potentially lower cost alternative to an electric braking regeneration system to save fuel costs.

The amount of energy stored in an accumulator is a function of the accumulator pressure and the volume of fluid stored in the accumulator. The temperature of the system, the type of gas used to pre-charge the system, and the initial pressure of the pre-charge gas can impact the amount of energy stored at a given accumulator pressure. The equation to calculate the energy stored in an accumulator is:

E=(Pc*Vc−(P*Vc*((Pc/P)̂(1/k))))/(1−k)

Where:

E is the energy stored in the accumulator.

Pc is the pre-charge pressure of the accumulator.

Vc is the volume of gas in the accumulator at pre-charge.

P is the current accumulator pressure. And

k is ratio of specific heats (Boltzmann constant) for the pre-charge gas.

The value of k for a gas varies with pressure at high pressures; values of 1.3 to 1.8 may be used for typical gases and pressures.

The pre-charge gas, pre-charge pressure, and volume of gas in the accumulator will not vary on a trailer during operation. Thus, the State Of Charge (SOC) of a hydraulic accumulator is a function only of its pressure. Although the accumulator pressure will vary with charge gas temperature, the SOC can be determined with acceptable accuracy even if this term is ignored.

A hydraulic braking regeneration system is potentially less expensive than an electric braking regeneration system, but, depending on the practical limits of the size of the accumulator, may have limited energy storage. The hydraulic motor generator would replace the power conditioner module 175 to power the refer and accessory electrical loads 180.

In another embodiment of the braking regeneration system, the braking regeneration system utilizes an axle load sensor and an algorithm to control regeneration and propulsion torque to limits compatible with tire traction.

In a further embodiment of the breaking regeneration system, the braking regeneration system utilizes a hitch load cell to provide a pulling thrust measurement for use by an algorithm to control wheel slip during braking and acceleration.

Yet in another embodiment of the braking regeneration system, the braking regeneration system utilizes a set of wheel speed sensors, one on each side of the trailer, for use by a control algorithm to prevent wheel slip during braking and acceleration.

In a still further embodiment of the braking regeneration system, a motor/generator is part of one or more wheels on each side of the trailer or part of the axle that drives the wheels on each side of the trailer without a combined gear box or differential gear operatively coupled to a common axle connected to two or more wheels on each side of the trailer. In this embodiment, the system is configured so that different torques are applied to the traction wheels on opposite sides of the trailer to assist the tow vehicle's steering of the trailer in a forward and/or reverse direction.

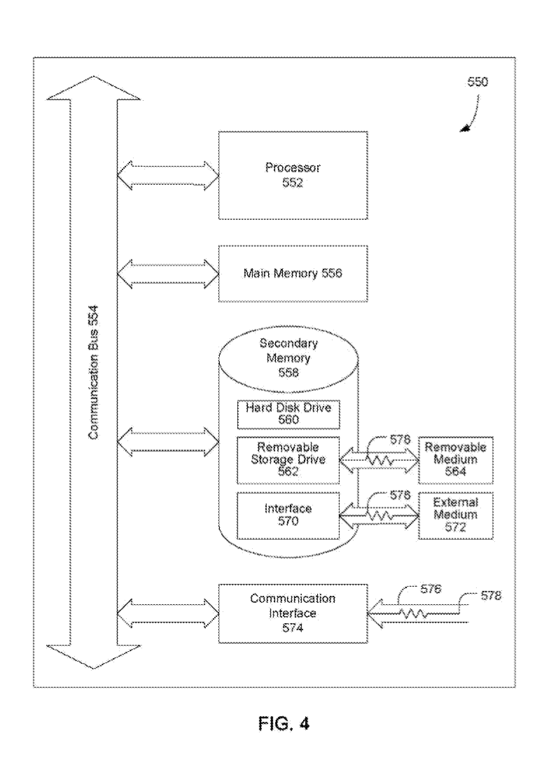

FIG. 4 is a block diagram illustrating an exemplary computer system 550 that may be used in connection with the various embodiments described herein. For example, the computer system 550 (or various components or combinations of components of the computer system 550) are used in conjunction with the control computer 200 described above. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface trailerd (“NIC”), a communications port, a PCMCIA slot and trailerd, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 trailerries signals 578 and can be implemented using a variety of wired or wireless communication means including wire or cable, fiber optics, conventional phone line, cellular phone link, wireless data communication link, radio frequency (RF) link, or infrared link, just to name a few. This could be especially useful for the remote reporting of trailer location and status, either independent of or in coordination with a similar reporting system on the towing vehicle or other trailers.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A braking regeneration and propulsion system for a passive trailer including wheels with, axles the passive trailer primarily propelled by a separate driving truck or tractor, comprising:
a motor/generator operatively coupled to the axle;
an energy storage system for storing captured energy and supplying energy; and
a control computer to assist deceleration of the passive trailer by causing the axle to drive the motor/generator and supply energy to the energy storage system during deceleration, and, assist acceleration of the passive trailer by causing the motor/generator to draw energy from the energy storage system and drive the axles and wheels during acceleration.

2. The system of claim 1, wherein the energy storage system is one or more of a battery, ultracapacitor, spring, and flywheel.

3. The braking regeneration and propulsion system of claim 1, wherein the motor/generator is operatively coupled to the axle through one of a gear box and a direct coupling for assisting deceleration and assisting acceleration.

4. The braking regeneration and propulsion system of claim 3, wherein the gear box includes one or more of a clutch, multiple gears, differential gears, and a transmission.

5. The braking regeneration and propulsion system of claim 1, wherein the trailer braking regeneration and propulsion system is axle-mounted.

6. The braking regeneration and propulsion system of claim 1, further including an inverter between the motor/generator and the energy storage system.

7. The braking regeneration and propulsion system of claim 1, wherein the control computer includes sensor inputs and is configured to prevent lurching of the passive trailer.

8. The braking regeneration and propulsion system of claim 1, wherein the passive trailer is one of many passive trailers primarily propelled by a separate towing truck, the braking regeneration and propulsion system is one of many braking regeneration and propulsion systems for the passive trailers, the control computer is one of many control computers, and the control computers include sensor inputs and are configured to control the braking regeneration and propulsion systems to prevent lurching of the passive trailers.

9. The braking regeneration and propulsion system of claim 1, wherein the passive trailer is at least one of a flat bed trailer, a tank trailer, a box trailer, a bulk materials trailer, a container trailer, a specialty trailer, a refrigeration unit trailer, and a bob tail trailer.

10. The braking regeneration and propulsion system of claim 1, wherein the passive trailer includes more than one axle with wheels and a separate braking regeneration and propulsion system for each axle, and each axle includes one of a separate gear box coupling and separate direct coupling; and a separate motor/generator for each axle.

11. The braking regeneration and propulsion system of claim 1, wherein the braking regeneration and propulsion system includes a braking resistor to dissipate excess energy generated by the braking regeneration and propulsion system.

12. The braking regeneration and propulsion system of claim 1, wherein the passive trailer includes multiple axles, and only one of the axles includes the braking regeneration and propulsion system.

13. The system of claim 1, wherein the control computer transfers power from the towing tractor by using the tractor to turn the wheels/axles of the passive trailer.

14. The braking regeneration and propulsion system of claim 1, wherein the motor/generator is integrated into one or more of the wheels.

15. The braking regeneration and propulsion system of claim 1, wherein the energy storage is used to power onboard accessories that are at least one of a refrigeration system, an air compressor, an HVAC system, cooling pumps, cooling and exhaust fans, a hydraulic pump, lighting systems, electric accessory appliances such as cooking, heating, hair drying, pumping water, and electronic accessories including navigation, communication, radio, television, audio and video entertainment, and general computing.

16. The trailer braking regeneration and propulsion system of claim 1, wherein the motor/generator is a hydraulic motor/pump, and the energy storage system is a hydraulic accumulator.

17. The system of claim 16, wherein the trailer braking regeneration and propulsion system is axle-mounted.

18. The braking regeneration and propulsion system of claim 16, further including a hydraulic controller between the motor/pump and the energy storage system.

19. The braking regeneration and propulsion system of claim 16, wherein the control computer has sensor inputs and is configured to prevent lurching of the passive trailer.

20. The braking regeneration and propulsion system of claim 16, wherein the passive trailer is one of many passive trailers primarily propelled by a separate towing truck or tractor, the braking regeneration and propulsion system is one of many braking regeneration and propulsion systems for the passive trailers, the control computer is one of many control computers, and the control computers have sensor inputs are configured to control the braking regeneration and propulsion systems to prevent lurching of the passive trailers.

21. The braking regeneration and propulsion system of claim 16, wherein the passive trailer is at least one of a flat trailer, a tank trailer, a box trailer, a bulk materials trailer, a container trailer, a specialty trailer, a refrigeration unit trailer, and a bobtail.

22. The braking regeneration and propulsion system of claim 16, wherein the passive trailer includes more than one axle with wheels and a separate braking regeneration and propulsion system for each axle, and each axle includes one of a separate gear box coupling and separate direct coupling; and a separate motor/generator for each axle.

23. The braking regeneration and propulsion system of claim 16, wherein the braking regeneration and propulsion system includes a hydraulic brake retarder to dissipate excess energy generated by the braking regeneration and propulsion system.

24. The braking regeneration and propulsion system of claim 16, wherein the passive trailer includes multiple axles, and only one of the axles includes the braking regeneration and propulsion system.

25. The system of claim 16, wherein the control computer transfers power from the towing tractor by using the tractor to turn the wheels/axles of the passive trailer.

26. A method of using a braking regeneration and propulsion system with a passive trailer including wheels with, axles the passive trailer primarily pulled by a separate towing truck or tractor, comprising:
providing a braking regeneration and propulsion system including:
a motor/generator operatively coupled to the axle;
an energy storage system for storing captured energy and supplying energy; and
a control computer to assist deceleration of the passive trailer by causing the axle to drive the motor/generator via the gear box and supply energy to the energy storage system, and, assist acceleration of the passive trailer by causing the motor/generator to draw energy from the energy storage system and drive the axles and wheels;
assisting deceleration of the passive trailer by causing the axle to drive the motor/generator and supply energy to the energy storage system;
assisting acceleration of the passive trailer by causing the motor/generator to draw energy from the energy storage system and drive the axles and wheels.

27. The method of claim 26, wherein the energy storage system is one or more of a battery, ultracapacitor, and flywheel.

28. The braking regeneration and propulsion method of claim 26, wherein the motor/generator is operatively coupled to the axle through one of a gear box and a direct coupling for assisting deceleration and assisting acceleration.

29. The braking regeneration and propulsion method of claim 28, wherein the gear box includes one or more of a clutch, multiple gears, differential gears, and a transmission.

30. The method of claim 26, wherein the braking regeneration and propulsion system is axle-mounted.

31. The method of claim 26, further including an inverter between the motor/generator and the energy storage system.

32. The method of claim 26, wherein the control computer includes sensor inputs and is configured to prevent lurching of the passive trailer.

33. The method of claim 26, wherein the passive trailer is one of many passive trailers primarily pulled by a separate towing truck or tractor, the braking regeneration and propulsion system is one of many braking regeneration and propulsion systems for the passive trailers, the control computer is one of many control computers, and the control computers have sensor inputs and are configured to control the braking regeneration and propulsion systems to prevent lurching of the passive trailers.

34. The method of claim 26, wherein the passive trailer is at least one of a flat bed trailer, a tank trailer, a box trailer, a bulk materials trailer, a container trailer, a specialty trailer, a refrigeration unit trailer, and a bob tail trailer.

35. The method of claim 26, wherein the passive trailer includes more than one axle with wheels and a separate braking regeneration and propulsion system for each axle, and each axle includes one of a separate gear box coupling and separate direct coupling; and a separate motor/generator for each axle.

36. The method of claim 26, wherein the braking regeneration and propulsion system includes a braking resistor to dissipate excess energy generated by the braking regeneration and propulsion system.

37. The method of claim 26, wherein the passive trailer includes multiple axles, and only one of the axles includes the braking regeneration and propulsion system.

38. The method of claim 26, wherein the control computer transfers power from the towing tractor by using the tractor to turn the wheels/axles of the passive trailer.

39. The method of claim 26, wherein the motor/generator is integrated into one or more of the wheels.

40. The braking regeneration and propulsion method of claim 26, wherein the energy storage is used to power onboard accessories that are at least one of a refrigeration system, an air compressor, an HVAC system, cooling pumps, cooling and exhaust fans, a hydraulic pump, lighting systems, electric accessory appliances such as cooking, heating, hair drying, pumping water, and electronic accessories including navigation, communication, radio, television, audio and video entertainment, and general computing.

41. The method of claim 26, wherein the motor/generator is a hydraulic motor/pump, and the energy storage system is a hydraulic accumulator.

42. The method of claim 41, wherein the trailer braking regeneration and propulsion system is axle-mounted.

43. The method of claim 41, further including a hydraulic controller between the motor/pump and the energy storage system.

44. The method of claim 41, wherein the control computer includes sensor inputs and is configured to prevent lurching of the passive trailer.

45. The method of claim 41, wherein the passive trailer is one of many passive trailers primarily pulled by a separate towing truck or tractor, the braking regeneration and propulsion system is one of many braking regeneration and propulsion systems for the passive trailers, the control computer is one of many control computers, and the control computers have sensor inputs and are configured to control the braking regeneration and propulsion systems to prevent lurching of the passive trailers.

46. The method of claim 41, wherein the passive trailer is at least one of a flat bed trailer, a tank trailer, a box trailer, a bulk materials trailer, a container trailer, a specialty trailer, a refrigeration unit trailer, and a bob tail trailer.

47. The method of claim 41, wherein the passive trailer includes more than one axle with wheels and a separate braking regeneration and propulsion system for each axle, and each axle includes one of a separate gear box coupling and separate direct coupling; and a separate motor/generator for each axle.

48. The method of claim 41, wherein the braking regeneration and propulsion system includes a hydraulic brake retarder to dissipate excess energy generated by the braking regeneration and propulsion system.

49. The method of claim 41, wherein the passive trailer includes multiple axles, and only one of the axles includes the braking regeneration and propulsion system.

50. The method of claim 41, wherein the energy storage system is a hydraulic accumulator.

51. The method of claim 41, wherein the control computer transfers power from the towing tractor by using the tractor to turn the wheels/axles of the passive trailer.
